(19) United States
(12) Patent Application Publication
(10) Pub. No.: US 2005/0119923 A1
(43) Pub. Date: Jun. 2, 2005

(54) Value movement forecasting system and method

(76) Inventors: Maxim Ladonnikov, Saratoga, CA (US); Christopher Kenneth Koverman, San Jose, CA (US)

Correspondence Address: CARR & FERRELL LLP, 2200 GENG ROAD, PALO ALTO, CA, 94303, US

(21) Appl. No.: 10/727,185

(22) Filed: Dec. 2, 2003

(51) Int. Cl. G06F 17/60

(52) U.S. Cl. 705/7

(57) ABSTRACT

A system and method for computing a value movement forecast for a financial measure collects publications related to the financial measure. Keyword expressions related to the financial measure are obtained. Linguistic analysis is performed on the publications to identify significant word expressions from the publications, identify characteristic variables based on predetermined characteristics of the keyword expressions and the significant word expressions, and compute values for the characteristic variables based on the predetermined characteristics of the keyword expressions and significant word expressions. A forecasting function is created based on the characteristic variables and the values. Values for the characteristic variables are then computed by performing linguistic analysis on another set of publications, and the forecasting function is evaluated on these values to compute the value movement forecast for the financial measure.

### BACKGROUND

1. Field of the Invention

The present invention relates generally to systems and methods of financial analysis and more particularly to systems and methods of forecasting value movements.

2. Background Art

In the financial services industry, an analysis of economic data is often performed to forecast value movements of various financial measures. These financial measures range from broad stock market indexes to equity share prices to publicly available socioeconomic statistics. Once the value movements of the financial measures are forecast, a financial decision can be made based on the forecasted value movements. The success of the financial decision often depends on the accuracy of the forecasted value movements.

Various methods and techniques have been employed to forecast the value movement of a financial measure. In one approach, a mathematical model is evaluated on numerical economic data. The numerical economic data typically includes economic statistics or well-defined and easily ascertainable economic values, such as an unemployment rate or an inflation rate.

Known systems and methods for forecasting value movements of financial measures have provided limited predictive accuracy. Although some of these systems and methods have accurately forecast value movements of financial measures in some instances, these systems and methods have not accurately forecast value movements of financial measures in other instances. Accordingly, there exists a need for a system and method that can accurately and reliably forecast a value movement of a financial measure.

### SUMMARY OF THE INVENTION

The present invention addresses the need for a system and method that can accurately and reliably forecast a value movement of a financial measure.

In a method in accordance with the present invention, a first set of publications is collected based on a financial measure. Characteristic variables are identified by performing linguistic analysis on the first set of publications. One or more values (i.e., first values) are computed for each characteristic variable based on the first set of publications. A forecasting function is created based on the characteristic variables and the first values.

A second set of publications is collected based on the financial measure and a value (i.e., second value) is computed for each characteristic variable by performing linguistic analysis on the second set of publications. A value movement forecast for the financial measure is then computed based on the forecasting function and the second values.

A system in accordance with the present invention includes a publication collection engine that collects a first set of publications based on a financial measure. A forecasting function generator identifies characteristic variables and computes one or more values (i.e., first values) for each characteristic variable by performing linguistic analysis on the first set of publications. Additionally, the forecasting function generator creates a forecasting function for the financial measure based on the characteristic variables and the first values.

The publication collection engine collects a second set of publications based on the financial measure. A value movement forecast generator computes a value (i.e., second value) for each characteristic variable by performing linguistic analysis on the second set of publications. The value movement forecast generator then computes a value movement forecast for the financial measure based on the forecasting function and the second values.

A computing system in accordance with the present invention includes a computing processor, a memory device, an input-output device, a publication collection engine and a forecasting function generator. The computing processor executes the publication collection engine to collect a first set of publications based on a financial measure and to read the first set of publications from the input-output device into the memory device. The computing processor executes the forecasting function generator to identify characteristic variables and compute one or more values (i.e., first values) for each characteristic variable by performing linguistic analysis on the first set of publications, and to create a forecasting function based on the characteristic variables and the first values.

The computing system can also include a value movement forecast generator. The computing processor executes the publication collection engine to collect a second set of publications based on the financial measure and to read the second set of publications from the input-output device into the memory device. The computing processor executes the value movement forecast generator to determine a value (i.e., second value) for each characteristic variable by performing linguistic analysis on the second set of publications, and to compute a value movement forecast for the financial measure based on the forecasting function and the second values.

### BRIEF DESCRIPTION OF THE DRAWINGS

FIG. 1 is a block diagram of a prior art computing system;

FIG. 2 is a block diagram of a value movement forecasting system, in accordance with the present invention;

FIG. 3 is a block diagram of the publication collection portion of the value movement forecasting system shown in FIG. 2, in accordance with one embodiment of the present invention;

FIG. 4 is a block diagram of the forecasting function generating portion of the value movement forecasting system shown in FIG. 2, in accordance with one embodiment of the present invention;

FIG. 5 is a block diagram of the value movement forecasting portion of the value movement forecasting system shown in FIG. 2, in accordance with one embodiment of the present invention;

FIG. 6 is a flow chart of a method for creating a forecasting function and computing a value movement forecast, in accordance with the present invention;

FIG. 7 is a flow chart of a portion of the method shown in FIG. 6 for identifying characteristic variables, in accordance with one embodiment of the present invention; and

FIG. 8 is a flow chart of a portion of the method shown in FIG. 6 for identifying characteristic variables, in accordance with another embodiment of the present invention.

### DETAILED DESCRIPTION OF THE PREFERRED EMBODIMENT

In accordance with the present invention, a set of publications related to a financial measure and published during a characteristic period in which the financial measure exhibits a value movement is analyzed to identify linguistic characteristics and their values in the set of publications. A mathematical model is created based on the linguistic characteristics to compute a forecast for the value movement based on values of the linguistic characteristics. Another set of publications related to the financial measure and published during a forecast period is analyzed to compute values for the linguistic characteristics in this set of publications. The mathematical model is then evaluated on these values to compute a value movement forecast for the financial measure relative to the forecast period.

The first set of publications related to the financial measure and published during the characteristic period is collected from publicly or privately available publications. The linguistic characteristics identified in the first set of publications include word expression pairs, each including a keyword expression and a significant word expression. The keyword expressions are words or combinations of words related to the financial measure that are obtained from a source (e.g., an expert in the relevant art). The significant word expressions are words or combinations of words identified from the first set of publications by performing linguistic analysis on the first set of publications. A predetermined characteristic of each word expression pair (e.g., frequency of appearance of the word expression pair in the first set of publications) is identified as a characteristic variable and one or more values (i.e., first values) are computed for the characteristic variable. A forecasting function is created for the financial measure based on the characteristic variables and the first values. The second set of publications related to the financial measure and published during the forecast period is collected from publicly or privately available publications. Linguistic analysis is performed on the second set of publications to identify word expression pairs and compute a value (i.e., second value) for each characteristic variable based on the predetermined characteristic (e.g., frequency of appearance of the word expression pair in the second set of publications). The forecasting function is then evaluated on the second values to compute a value movement forecast for the financial measure relative to the forecast period (i.e., a predicted value movement of the financial measure that is to occur after the forecast period).

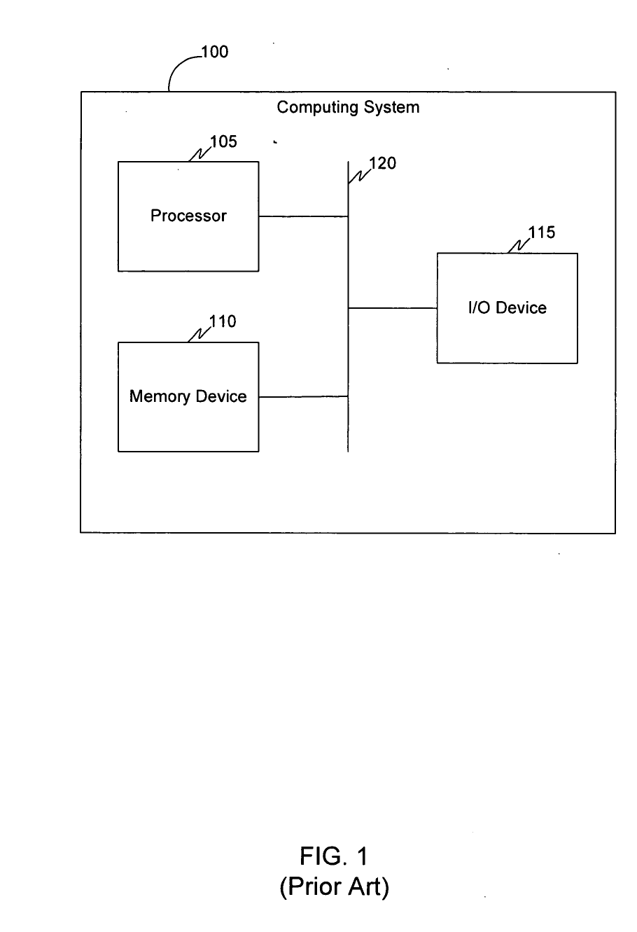

Referring to FIG. 1, a general purpose computing system 100 known in the art is shown. The computing system 100 includes a processor 105, a memory device 110 and an input-output device 115 that are each coupled to a computer bus 120 and communicate with each other through the computer bus 120. The processor 105 communicates with the memory device 110 to retrieve data from the memory device 110 and to store data into the memory device 110. Additionally, the processor 105 and the memory device 110 communicate with the input-output device 115 to obtain data from and provide data to the input-output device 115.

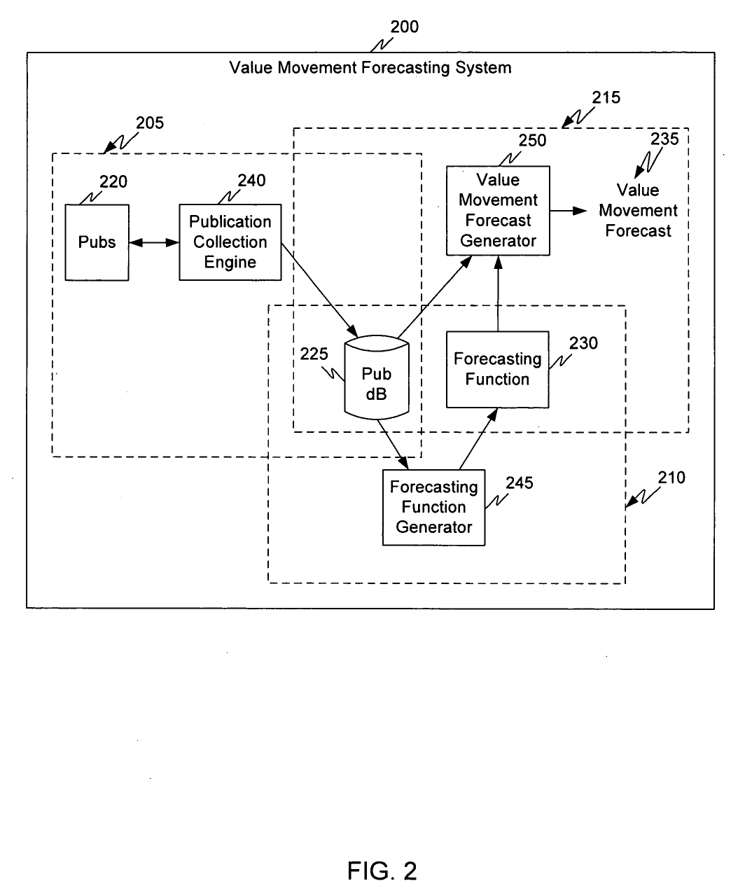

Referring now to FIG. 2, a value movement forecasting system 200 in accordance with the present invention is shown. The value movement forecasting system 200 includes a publication collection portion 205, a forecasting function generating portion 210 and a value movement forecasting portion 215. The publication collection portion 205 accesses publications 220 to select and retrieve publications related to a financial measure. The publication collection portion 205 stores the selected publications into a publication database 225, as is explained more fully herein. The forecasting function generating portion 210 generates a forecasting function 230 for the financial measure based on selected publications in the publication database 225, as is explained more fully herein. The value movement forecasting portion 215 computes a value movement forecast 235 for the financial measure based on selected publications in the publication database 225 and the forecasting function 230, as is explained more fully herein.

The publication collection portion 205 of the value movement forecasting system 200 includes publications 220, a publication collection engine 240 and the publication database 225. The publications 220 can be any information that is in an electronic format, convertible into an electronic format, or readable with an electronic device. Further, the publications 220 can be publicly available information or private information. For example, a publication 220 can be a news article accessible via the Internet or the close caption text in a television broadcast. As another example, a publication 220 can be a text file in a personal computing system or a computer record in a computer database.

The publication collection engine 240 accesses the publications 220 to select and retrieve publications related to the financial measure. For example, the publication engine 240 can query a computer database to retrieve publications (i.e., records) related to the financial measure. As another example, the publication engine 240 can execute a search based on the financial measure by using a search engine to identify websites on the Internet and retrieve publications contained in the web pages of the websites (i.e., scrape the website to identify and extract information from the web pages in the websites). The publication collection engine 240 stores the selected publications into the publication database 225, as is explained more fully herein. Additionally, the publication collection engine 240 can filter the selected publications before storing the selected publications into the publication database 225, as is explained more fully herein.

The forecasting function generating portion 210 of the value movement forecasting system 200 includes the publication database 225, a forecasting function generator 245, and the forecasting function 230. The forecasting function generator 245 selects and accesses a first set of publications in the publication database 225 and generates the forecasting function 230 based on the first set of publications in the publication database 225, as is explained more fully herein.

The value movement forecasting portion 215 of the value movement forecasting system 200 includes the publication database 225, the forecasting function 230 and a value movement forecast generator 250. The value movement forecast generator 250 selects and accesses a second set of publications in the publication database 225 and generates a value movement forecast 235 based on the second set of publications in the publication database 225 and the forecasting function 230, as is explained more fully herein. Additionally, the value movement forecast generator 250 can select and access other sets of publications in the publication database 225, generate a value movement forecast 235 for each of these sets of publications, and compare each of these value movement forecasts 235 to value movement characteristics exhibited by the financial measure to evaluate the effectiveness of the forecasting function 230, as is described more fully herein. For example, the value movement forecast generator 250 can evaluate the accuracy, consistency and reliability of the forecasting function 230 on different sets of publications in the publication database 225 to determine whether the forecasting function 230 meets a given set of specifications (e.g., production standards).

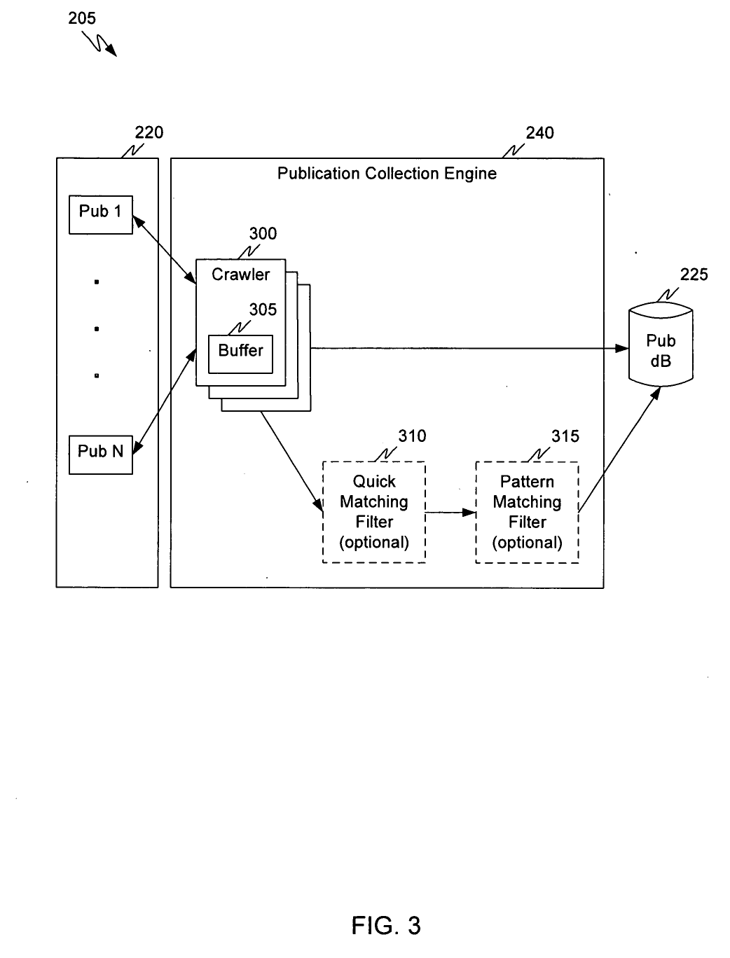

Referring now to FIG. 3, one embodiment of the publication collection portion 205 of the value movement forecasting system 200 is shown. In this embodiment, the publication collection engine 240 includes a crawler 300, which includes a buffer 305. The crawler 300 selects and retrieves publications related to the financial measure from the publications 220 and stores the selected publications in the buffer 305 of the crawler 300. For example, the crawler 300 can perform a search on the Internet to retrieve the selected publications related to the financial measure. The crawler 300 transfers the selected publications in the buffer 305 of the crawler 300 to the publication database 225. In one embodiment, the crawler 300 periodically transfers the selected publications in the buffer 305 of the crawler 300 to the publication database 225.

In another embodiment, multiple crawlers 300 perform a search on the Internet to retrieve the selected publications related to the financial measure from the publications 220. In this embodiment, the crawlers 300 can execute the same searching algorithm or different searching algorithms to select and retrieve publications from the publications 220 based on a search key related to the financial measure. For example, each crawler 300 can execute the same search engine (e.g., the search function of MSN.com) with a search key (e.g., the text “Semiconduct*”) that is related to a financial measure (e.g., the Philadelphia Semiconductor Index). The search key can be a word, word fragment, phrase or combination of words that is related to the financial measure. Further, each word or word fragment in the search key can include a wildcard character (e.g., “*”) to include expansions of the word or word fragment in the search (i.e., word stemming). As another example, each crawler 300 can execute a different search engine with the search key that is related to the financial measure. Multiple crawlers 300 can improve the reliability of the publication collection engine 240 but may result in duplicate selected publications in the publication database 225.

In another embodiment, the publication collection engine 240 includes a quick matching filter 310 and a pattern matching filter 315. In this embodiment, the crawlers 300 transfer the selected publications in the buffers 305 of the crawlers 300 to the quick matching filter 310. The quick matching filter 310 receives the selected publications from the crawlers 300, filters out duplicate publications, and transfers the remaining publications to the pattern matching filter 315. Duplicate publications are identical publications selected and retrieved by the crawlers 300 from the publications 220.

In this embodiment, the crawlers 300 compute a hash function (e.g., checksum) for each selected publication retrieved from the publications 220. The crawlers 300 transfer the hash functions together with the corresponding selected publications to the quick matching filter 315. The quick matching filter 315 receives the selected publications and hash functions from the crawlers 300 and filters out duplicate publications based on the hash functions (e.g., removes publications that have the same hash function).

Further, in this embodiment, the pattern matching filter 315 receives the filtered publications from the quick matching filter 310, filters out similar publications, and transfers the remaining publications to the publication database 225. A publication is considered similar to another publication if the text in these publications is not identical but the information conveyed by these publications is essentially the same (e.g., the publications include the same syndicated content). The filtering methods and techniques used in the quick matching filter 310 and the pattern matching filter 315 are known in art. A discussion of some of these methods and techniques can be found in “On the resemblance and containment of documents” by Andrei Z. Broder, In Compression and Complexity of Sequences (SEQUENCES '97), pp. 21-29 (IEEE Computer Society, 1998), which is incorporated herein by reference in its entirety.

It is to be understood that the quick matching filter 310 and the pattern matching filter 315 are optional in the publication collection engine 240. It is to be further understood that the publication collection engine 240 can include the quick matching filter 310 or the pattern matching filter 315, or both.

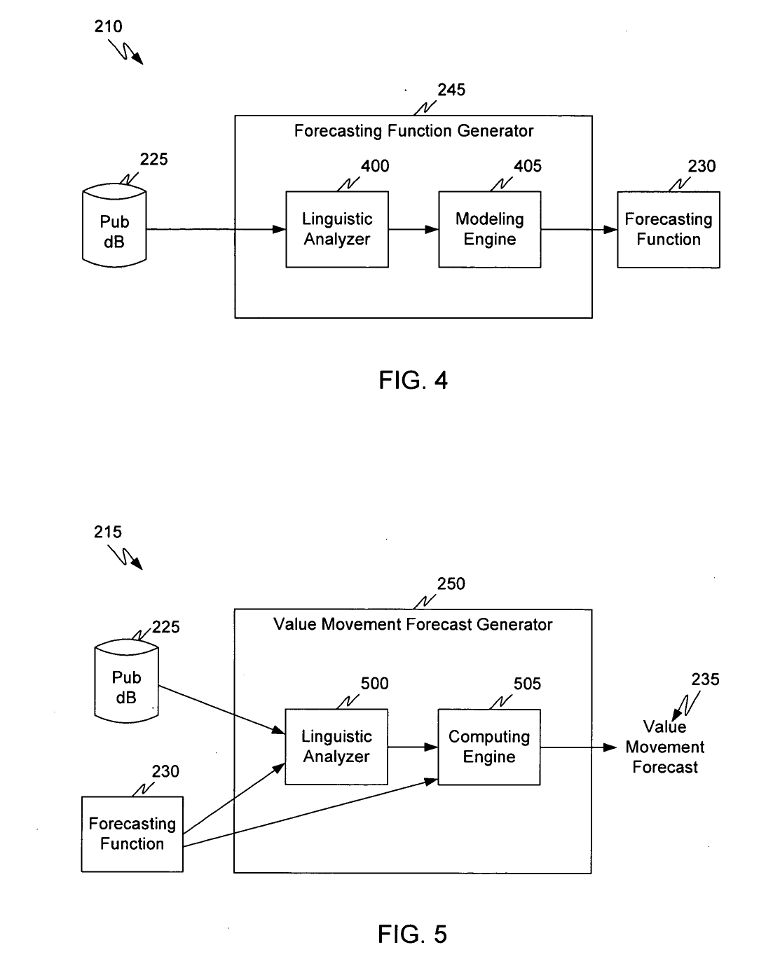

Referring now to FIG. 4, one embodiment of the forecasting function generating portion 210 is shown. In this embodiment, the forecasting function generator 245 includes a linguistic analyzer 400 and a modeling engine 405. The linguistic analyzer 400 selects a first set of publications in the publication database 225 based on a characteristic period, identifies characteristic variables for the first set of publications, and computes one or more first values for each characteristic variable, as is explained more fully herein. The modeling engine 405 creates the forecasting function 230 based on the characteristic variables and the first values, as is explained more fully herein.

The linguistic analyzer 400 identifies publications from the publication database 225 that are associated with a characteristic period to select the first set of publications. In one embodiment, the linguistic analyzer 400 identifies publications in the publication database 225 that have been published within the characteristic period to select the first set of publications. The characteristic period is a period during which the financial measure has exhibited value movement characteristics that are to be forecast by the value movement forecasting portion 215 of the value movement forecasting system 200. For example, a value movement characteristic can be a rising value, falling value, or flat value of a financial measure, such as a commodity value or equity share price. In one embodiment, the characteristic period is subdivided into a number of time slices that is equal to the number of first values of each characteristic variable, as is explained more fully herein. For example, the characteristic period can be a period of months or years and each time slice can be a period of hours, days, weeks or months.

It is to be understood that the characteristic period need not be a single period in the present invention, and the characteristic period can be a collection of periods in which the financial measure exhibits the value movement characteristics that are to be forecast. For example, the characteristic period can be a collection of isolated and noncontiguous periods in which the financial measure exhibits at least one of the value movement characteristics that is to be forecast.

The linguistic analyzer 400 performs linguistic analysis on the first set of publications in the publication database 225 to identify characteristic variables for the first set of publications in the publication database 225, as is explained more fully herein. Additionally, the linguistic analyzer 400 performs linguistic analysis to compute one or more first values for each characteristic variable from the first set of publications in the publication database 225, as is explained more fully herein. The linguistic analysis performed by the linguistic analyzer 400 is based on linguistic analysis methods and techniques known in the art. A discussion of some of these methods and techniques can be found in “Statistical Language Learning” by Eugene Charniak (The MIT Press, 1994) and “Untangling Text Data Mining” by Marti A. Hearst (Proceedings of ACL'99: the 37^{th} Annual Meeting of the Association for Computational Linguistics, University of Maryland, Jun. 20-26, 1999), which are incorporated herein by reference in their entireties.

The linguistic analyzer 400 identifies characteristic variables based on word expression pairs in the first set of publications in the publication database 225, as is explained more fully herein. Each word expression pair includes a keyword expression and a significant word expression. The keyword expressions can be words, phrases or combinations of words related to the financial measure that are selected by an expert in the relevant field. For example, the financial measure can be the Philadelphia Stock Market Index (SOXX) and the keyword expressions can include “earnings”, “revenue” and “sales”. The significant word expressions can be words, phrases or combinations of words derived from selected publications in the first set of publications that summarize the content of the selected publications. In this example, the significant word expressions can be “income”, “cash flow” and “net sales”. Further, in this example, a word expression pair can be the keyword expression “earnings” paired with the significant word expression “cash flow”.

The linguistic analyzer 400 computes one or more first values for each characteristic variable based on the predetermined characteristic. The first value of a characteristic variable is computed based on the publications 220 published or collected within the characteristic period. In one embodiment, the predetermined characteristic is the frequency of appearance of both the significant word expression and the keyword expression of a word expression pair identified in the first set of publications in the publication database 225. In another embodiment, the characteristic period is subdivided into time slices and a first value is computed for each time slice for each characteristic variable.

The modeling engine 405 creates the forecasting function 230 based on the characteristic variables and the first values. The forecasting function 230 has one or more of the characteristic variables as inputs and the value movement forecast 235 as an output. The forecasting function 230 can be a mathematical function, a mathematical model, a computing function, or a computing program. In one embodiment, the forecasting function 230 is a mathematical model developed based on statistical learning techniques known in the relevant art. In another embodiment, the forecasting function 230 is a statistical function. In this embodiment, the number of first values of each characteristic variable is a statistically significant number and the characteristic period is subdivided into a number of time slices that is equal to the number of first values. Further, in this embodiment, each first value of a characteristic variable corresponds to a time slice and is computed based on the publications in the first set of publications in the publication database 225 that have been published or collected within the time slice.

It is to be understood that the methods and techniques for creating the forecasting function 230 are not limited to the examples presented herein, and that the forecasting function generator 245 can employ any methods or techniques known in the art to create the forecasting function 230. Some of the methods and techniques known in the relevant art for developing the forecasting function 230 are described in “Machine Learning” by Tom M. Mitchell (McGraw-Hill, 1997), which is incorporated herein by reference in its entirety.

Referring now to FIG. 5, one embodiment of the value movement forecasting portion 215 is shown. In this embodiment, the value movement forecast generator 250 includes a linguistic analyzer 500 and a computing engine 505. The linguistic analyzer 500 selects a second set of publications in the publication database 225 based on a forecast period and computes a second value for each of the characteristic variables in the forecasting function 230 based on the second set of publications, as is explained more fully herein. The computing engine 505 evaluates the forecasting function 230 with the second values and generates the value movement forecast 235, as is explained more fully herein.

The linguistic analyzer 500 identifies publications from the publication database 225 that are associated with a forecast period to select the second set of publications. In one embodiment, the linguistic analyzer 500 identifies publications in the publication database 225 that have been published within the forecast period to select the second set of publications. The forecast period can be any period within, outside, or overlapping with the characteristic period. In one embodiment, the forecast period is outside of the characteristic period and is later than the characteristic period. In another embodiment, the length of the forecast period is the same as the length of a time slice in the characteristic period.

The linguistic analyzer 500 performs linguistic analysis on the second set of publications in the publication database 225 to compute a second value for each of the characteristic variables, as is described more fully herein. In one embodiment, the linguistic analyzer 500 identifies word expression pairs from the characteristic variables in the forecasting function 230. In this embodiment, the linguistic analyzer 500 performs linguistic analysis on second set of publications to compute the second value for each characteristic variable based on a predetermined characteristic of the word expression pairs (e.g., frequency of appearance of a word expression pair in the second set of publications). It is to be understood that the linguistic analyzer 400 of FIG. 4 and the linguistic analyzer 500 of FIG. 5 can be the same linguistic analyzer in the present invention.

The computing engine 505 evaluates the forecasting function 230 with the second values to compute the value movement forecast 235. In one embodiment, the computing engine 505 is a computing process that executes computer program code for evaluating the forecasting function 230 to compute the value movement forecast 235. The value movement forecast 235 is a predicted value movement for the financial measure relative to the forecast period (i.e., a predicted value movement of the financial measure that is to occur after the forecast period).

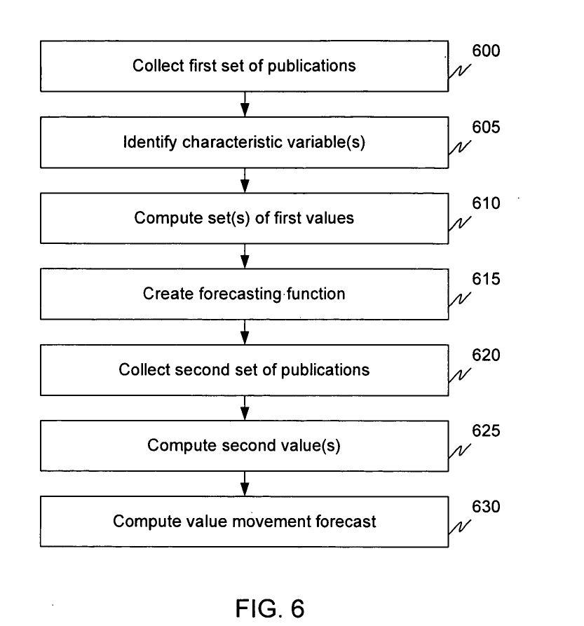

Referring now to FIG. 6, a flow chart of a method for computing the value movement forecast 235 is shown. In step 600, a first set of publications in the publication database 225 is collected based on a characteristic period. In this process, the publication collection engine 240 accesses publications 220 to select and retrieve publications related to a financial measure. The publication collection engine 240 stores the selected publications into the publication database 225, as is explained more fully herein. Further, the forecasting function generator 245 identifies publications in the publication database 225 as the first set of publications, based on a characteristic period, as is explained more fully herein.

In step 605, characteristic variables are identified for the first set of publications in the publication database 225. In this process, the forecasting function generator 245 performs linguistic analysis on the first set of publications to identify the characteristic variables for the first set of publications, as is explained more fully herein. In one embodiment, a linguistic analyzer 400 of the forecasting function generator 245 selects the first set of publications from the publication database 225 based on the characteristic period and performs linguistic analysis on the first set of publications to identify the characteristic variables.

In step 610, one or more first values are computed for each characteristic variable. In this process, the forecasting function generator 245 computes the first values for each characteristic variable based on the first set of publications and the predetermined characteristic (e.g., frequency of appearance of the word expression pair of the characteristic variable in the first set of publications in the publication database 225), as is explained more fully herein. In one embodiment, the linguistic analyzer 400 of the forecasting function generator 245 computes the first values for the characteristic variables, as is explained more fully herein.

In step 615, the forecasting function 230 is created. In this process, the forecasting function generator 245 creates the forecasting function 230 based on the characteristic variables and the first values, as is explained more fully herein. In one embodiment, the modeling engine 405 of the forecasting function generator 245 creates the forecasting function 230, as is explained more fully herein.

In step 620, a second set of publications in the publication database 225 is collected based on a forecast period. In this process, the publication collection engine 240 accesses publications 220 to select and retrieve publications related to the financial measure. The publication collection engine 240 stores the selected publications into the publication database 225, as is explained more fully herein. Further, the value movement forecast generator 250 identifies publications in the publication database 225 as the second set of publications, based on the forecast period, as is explained more fully herein.

In step 625, a second value is computed for each characteristic variable. In this process, the linguistic analyzer 500 of the value movement forecast generator 250 computes the second value for each characteristic variable based on the second set of publications and the predetermined characteristic (e.g., frequency of appearance of the word expression pair of the characteristic variable in the second set of publications in the publications database 225), as is explained more fully herein.

In step 630, the value movement forecast 235 is computed. In this process, the computing engine 505 of the value movement forecast generator 250 evaluates the forecasting function 230 on the second values to compute the value movement forecast 235, as is explained more fully herein.

Also in step 630, the value movement forecast generator 250 can evaluate the effectiveness of the forecasting function 230. In this process, the value movement forecast generator 250 accesses different sets of publications in the publication database 225 based on different periods during which the financial measure exhibits known value movement characteristics. The value forecast generator 250 generates a value movement forecast 235 for each set of publications and compares the value movement forecasts 235 to the corresponding value movement characteristics of the financial measure to evaluate the effectiveness of the forecasting function 230. For example, the value forecast generator 250 can evaluate the accuracy, consistency and reliability of the forecasting function 230 to determine whether the forecasting function 230 meets a given set of specifications (e.g., production standards) for commercial use of the forecasting function 230.

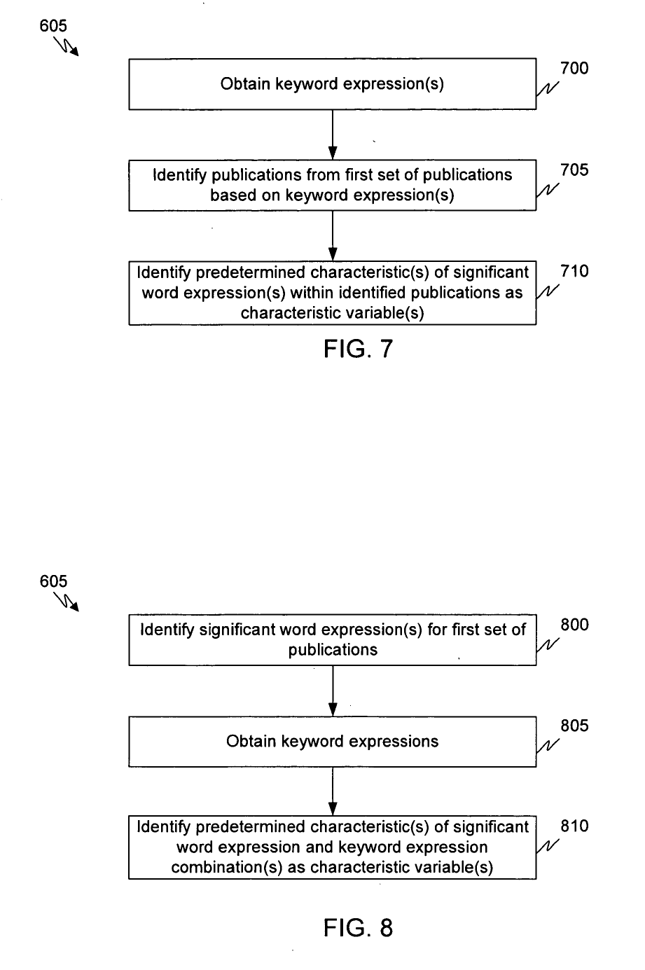

Referring now to FIG. 7, a flow chart of one embodiment of the portion of the method shown in FIG. 6 for identifying characteristic variables (step 605) is shown. In step 700, keyword expressions related to the financial measure are obtained. In one embodiment, an expert selects the keyword expressions based on knowledge of the relevant field.

In step 705, publications are identified from the first set of publications based on the keyword expressions. In this process, the linguistic analyzer 400 of the forecasting function generator 245 performs linguistic analysis on the first set of publications in the publication database 225 to identify for each keyword expression those publications that contain the keyword expression.

In step 710, one or more significant word expressions are identified within the identified publications for each keyword expression, and a predetermined characteristic of each significant word expression is identified as a characteristic variable. In this process, the linguistic analyzer 400 performs linguistic analysis on the publications identified for each keyword expression to identify one or more significant word expressions (i.e., one or more word expression pairs). Additionally, the linguistic analyzer 400 identifies a predetermined characteristic of each significant word expression (e.g., frequency of appearance of the significant word expression within the identified set of publications) as a characteristic variable, as is explained more fully herein.

Referring now to FIG. 8, a flow chart of another embodiment of the portion of the method shown in FIG. 6 for identifying characteristic variables (step 605) is shown. In step 800, significant word expressions are identified for the first set of publications in the publication database 225. In this process, the linguistic analyzer 400 of the forecasting function generator 245 performs linguistic analysis on the first set of publications in the publication database 225 to identify the significant words from the first set of publications.

In step 805, keyword expressions are obtained based on the financial measure. In one embodiment, an expert selects the keyword expressions based on knowledge of the relevant field.

In step 810, combinations of significant word expressions and keyword expressions are identified within the first set of publications, and a predetermined characteristic of each combination is identified as a characteristic variable. In this process, the linguistic analyzer 400 performs linguistic analysis on the first set of publications in the publication database 225 to identify combinations of significant word expressions and keyword expressions (i.e., word expression pairs). Additionally, the linguistic analyzer identifies a predetermined characteristic of each word expression pair (e.g., frequency of appearance of the word expression pair in the first set of publications) as a characteristic variable, as is explained more fully herein.

Although embodiments of the present invention have been explained herein with reference to a value movement forecast for a financial measure, it is to be appreciated that the present invention can be practiced to compute a value movement forecast of a non-financial measure. It is to be further appreciated that the present invention can be practiced to compute a value movement forecast of any measure that exhibits a value movement characteristic.

The embodiments discussed herein are illustrative of the present invention. As these embodiments of the present invention are described with reference to illustrations, various modifications or adaptations of the methods and/or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

1. A method comprising the steps of:
collecting a first set of publications based on a financial measure;
identifying characteristic variables by performing linguistic analysis on the first set of publications;
computing at least one first value for each characteristic variable based on the first set of publications; and
creating a forecasting function based on the characteristic variables and the first values.

2. A method as recited in claim 1, wherein identifying characteristic variables by performing linguistic analysis comprises:
obtaining keyword expressions related to the financial measure;
identifying publications from the first set of publications based on the keyword expressions; and
identifying as the characteristic variables predetermined characteristics of significant word expressions within the identified publications.

3. A method as recited in claim 1, wherein identifying characteristic variables by performing linguistic analysis comprises:
identifying significant word expressions for the first set of publications;
obtaining keyword expressions based on the financial measure; and
identifying as the characteristic variables predetermined characteristics of combinations of significant word expressions and keyword expressions.

4. A method as recited in claim 1, further comprising the steps of:
collecting a second set of publications based on the financial measure;
determining a second value for each characteristic variable by performing linguistic analysis on the second set of publications; and
computing a value movement forecast for the financial measure based on the forecasting function and the second values.

5. A method as recited in claim 4, further comprising the step of:
comparing the value movement forecast to value movement characteristics exhibited by the financial measure to evaluate the forecasting function.

6. A system comprising:
a publication collection engine configured to collect a first set of publications based on a financial measure; and
a forecasting function generator configured to identify characteristic variables and compute at least one first value for each characteristic variable by performing linguistic analysis on the first set of publications, and to create a forecasting function based on the characteristic variables and the first values.

7. A system as recited in claim 6, wherein identifying characteristic variables by performing linguistic analysis on the first set of publications comprises:
obtaining keyword expressions related to the financial measure;
identifying publications from the first set of publications based on the keyword expressions; and
identifying as the characteristic variables predetermined characteristics of significant word expressions within the identified publications.

8. A system as recited in claim 6, wherein identifying characteristic variables by performing linguistic analysis on the first set of publications comprises:
identifying significant word expressions from the first set of publications;
obtaining keyword expressions based on the financial measure; and
identifying as the characteristic variables predetermined characteristics of the combinations of significant word expressions and keyword expressions.

9. A system as recited in claim 6, wherein the publication collection engine is further configured to collect a second-set of publications based on the financial measure, the system further comprising a value movement forecast generator configured to determine a second value for each characteristic variable by performing linguistic analysis on the second set of publications and to compute a value movement forecast for the financial measure based on the forecasting function and the second values.

10. A system as recited in claim 6, wherein the publication collection engine comprises at least one crawler configured to retrieve the first set of publications based on the financial measure.

11. A system as recited in claim 6, wherein the publication collection engine further comprises a quick matching filter configured to filter out essentially identical publications from the first set of publications.

12. A system as recited in claim 6, wherein the publication collection engine further includes a pattern matching filter configured to filter out substantially similar publications from the first set of publications.

13. A system as recited in claim 6, further including a publication database configured to store the first set of publications.

14. A system s recited in claim 6, further including a publication database configured to store the second set of publications.

15. A system as recited in claim 6, wherein the forecasting function generator comprises a linguistic analyzer configure to identify the characteristic variables and compute the at least one first value for each characteristic variable by performing linguistic analysis on the first set of publications.

16. A system as recited in claim 6, wherein the forecasting function generator further comprises a modeling engine configured to create the forecasting function based on the characteristic variables and the first values.

17. A method as recited in claim 9, wherein the value movement forecast generator is further configured to compare the value movement forecast to value movement characteristics exhibited by the financial measure to evaluate the forecasting function.

18. A computing system comprising:
a publication collection engine;
a forecasting function generator;
a memory device;
an input-output device; and
a computing processor configured to execute the publication collection engine to collect a first set of publications based on a financial measure and read the first set of publications from the input-output device into the memory device, the computing processor further configured to execute the forecasting function generator to identify characteristic variables by performing linguistic analysis on the first set of publications, determine at least one first value for each characteristic variable based on the first set of publications and to create a forecasting function based on the characteristic variables and the first values.

19. A computing system as recited in claim 18, further comprising a value movement forecast generator, wherein the computing processor is further configured to execute the publication collection engine to collect a second set of publications based on the financial measure and read the second set of publications from the input-output device into the memory device, the computing processor further configured to execute the value movement forecast generator to determine a second value for each characteristic variable based on the second set of publications and to compute a value movement forecast for the financial measure based on the forecasting function and the second values.

20. A computing system as recited in claim 19, wherein the value movement forecast generator is further configured to compare the value movement forecast to value movement characteristics exhibited by the financial measure to evaluate the forecasting function.

21. A method comprising:
step-means for collecting a first set of publications based on a financial measure;
step-means for identifying characteristic variables based on the first set of publications;
step-means for computing at least one first value for each characteristic variable based on the first set of publications; and
step-means for creating a forecasting function based on the characteristic variables and the first values.

22. A method as recited in claim 21, further comprising:
step-means for collecting a second set of publications based on the financial measure;
step-means for computing a second value for each characteristic variable based on the second set of publications; and
step-means for computing a value movement forecast for the financial measure based on the forecasting function and the second values.

23. A method as recited in claim 22, further comprising:
step-means for comparing the value movement forecast to value movement characteristics exhibited by the financial measure to evaluate the forecasting function.

24. A system comprising:
means for collecting a first set of publications based on a financial measure;
means for identifying characteristic variables based on the first set of publications;
means for computing at least one first value for each significant word expression based on the first set of publications; and
means for creating a forecasting function based on the characteristic variables and the first values.

25. A system as recited in claim 24, further comprising:
means for collecting a second set of publications based on the financial measure;
means for computing a second value for each characteristic variable based on the second set of publications; and
means for computing a value movement forecast for the financial measure based on the forecasting function and the second values.

26. A method as recited in claim 25, further comprising:
means for comparing the value movement forecast to value movement characteristics exhibited by the financial measure to evaluate the forecasting function.

27. A computer program product including computer program code for performing the steps of:
collecting a first set of publications based on a financial measure;
identifying characteristic variables by performing linguistic analysis on the first set of publications;
computing at least one first value for each characteristic variable based on the first set of publications; and
creating a forecasting function based on the characteristic variables and the first values.

28. A computer program product as recited in claim 27, further comprising computer program code for performing the steps of:
collecting a second set of publications based on the financial measure;
computing a second value for each characteristic variable based on the second set of publications; and
computing a value movement forecast for the financial measure based on the forecasting function and the second values.

29. A computer program product as recited in claim 28, further comprising computer program code for performing the step of:
comparing the value movement forecast to value movement characteristics exhibited by the financial measure to evaluate the forecasting function.
